(19) United States
(12) Patent Application Publication
(10) Pub. No.: US 2016/0351155 A1
(43) Pub. Date: Dec. 1, 2016

(54) CHIP ON FILM PACKAGE AND DISPLAY DEVICE INCLUDING THE SAME

(71) Applicant: SAMSUNG ELECTRONICS CO., LTD., SUWON-SI (KR)

(72) Inventors: JIN-WOO PARK, SEOUL (KR); SO-YOUNG LIM, HWASEONG-SI (KR)

(21) Appl. No.: 15/165,464

(22) Filed: May 26, 2016

(30) Foreign Application Priority Data
May 27, 2015 (KR) 10-2015-0073928

(51) Int. Cl. G09G 3/36

(52) U.S. Cl. CPC G09G 3/3677; G09G 3/3688; G09G 2310/08; G09G 2330/021

(57) ABSTRACT

A chip on film (COF) package includes a base film, a semiconductor chip disposed on the base film, first signal wires, and second signal wires. The semiconductor chip includes a pads and a driving integrated circuit. The first signal wires are configured to output a drive signal generated in the driving integrated circuit, and are electrically connected to pads disposed in a first pad region. The first pad region is disposed on a first side of the semiconductor chip. The first signal wires are disposed on a first surface of the base film. The second signal wires are electrically connected to pads disposed in a second pad region. The second pad region is disposed on a second side of the semiconductor chip. The second signal wires are disposed on a second surface of the base film. The first and second surfaces of the base film are opposite to each other.

### CROSS-REFERENCE TO RELATED APPLICATION

This application claims priority under 35 U.S.C. §119 to Korean Patent Application No. 10-2015-0073928, filed on May 27, 2015, in the Korean Intellectual Property Office, the disclosure of which is incorporated by reference herein in its entirety.

### TECHNICAL FIELD

The inventive concept relates to a chip on film (COF) package and a display device including the same.

### DISCUSSION OF THE RELATED ART

A display device may be a self-luminous display device including a light emitting diode (LED) panel. The LED panel may supply light to a display panel, such as a liquid crystal display (LCD) panel, to display an image. Generally, the display device includes a display panel including a plurality of pixels, a drive unit providing a drive signal to the display panel, and a power supply unit providing power to the pixels of the display panel. The drive unit may be connected to the display panel using different mounting systems.

### SUMMARY

According to an exemplary embodiment of the inventive concept, a chip on film (COF) package includes a base film. A semiconductor chip is disposed on the base film, wherein the semiconductor chip includes a plurality of pads and a driving integrated circuit. First signal wires are configured to output a drive signal generated in the driving integrated circuit, wherein the first signal wires are electrically connected to pads disposed in a first pad region, wherein the first pad region is disposed on a first side of the semiconductor chip, and wherein the first signal wires are disposed on a first surface of the base film. Second signal wires are electrically connected to pads disposed in a second pad region, wherein the second pad region is disposed on a second side of the semiconductor chip, wherein the second signal wires are disposed on a second surface of the base film, and wherein the second surface of the base film is opposite to the first surface of the base film.

In an exemplary embodiment of the inventive concept, the first side of the semiconductor chip is longer than the second side of the semiconductor chip, and the pads of the first and second pad regions are arranged approximately orthogonal to each other.

In an exemplary embodiment of the inventive concept, a drive signal generated in the semiconductor chip is output through the second signal wires.

In an exemplary embodiment of the inventive concept, the second signal wires are configured to transmit an input signal to the semiconductor chip.

In an exemplary embodiment of the inventive concept, the input signal includes a power signal to supply power to the driving integrated circuit or a control signal to control the semiconductor chip.

In an exemplary embodiment of the inventive concept, the COF package further includes first via holes passing through the base film and first connecting wires disposed on a first surface of the base film, wherein the second signal wires are electrically connected to the first connecting wires through the first via holes.

In an exemplary embodiment of the inventive concept, the first and second signal wires extend in opposite directions with respect to each other.

In an exemplary embodiment of the inventive concept, the semiconductor chip further includes a third pad region disposed on the first side of the semiconductor chip, wherein the third pad region is adjacent to the second pad region.

In an exemplary embodiment of the inventive concept, the COF package further includes third signal wires connected to pads disposed in the third pad region, wherein the third signal wires are disposed on the first surface of the base film, and wherein the third signal wires are configured to transmit an input signal to the semiconductor chip.

In an exemplary embodiment of the inventive concept, the second pad region is disposed on the second side of the semiconductor chip, wherein the semiconductor chip further includes a fourth pad region disposed on a third side of the semiconductor chip, wherein the third side of the semiconductor chip faces the second side of the semiconductor chip. The COF package further includes fourth signal wires connected to pads disposed in the fourth pad region, wherein the fourth signal wires are disposed on the second surface of the base film, and wherein the fourth signal wires are configured to transmit an input signal to the semiconductor chip.

In an exemplary embodiment of the inventive concept, the second signal wires and the fourth signal wires are symmetrical to each other based on a reference line disposed between the second and fourth signal wires.

In an exemplary embodiment of the inventive concept, the driving integrated circuit is a scan driving circuit generating a scan signal or a data driving circuit generating a data signal.

According to an exemplary embodiment of the inventive concept, a display device includes a display panel including a plurality of pixels. A COF package includes a semiconductor chip disposed on a base film, wherein the semiconductor chip is configured to drive the display panel, wherein the COF package includes first signal wires and second signal wires. The first signal wires are electrically connected to pads disposed in a first pad region of the semiconductor chip, wherein the first signal wires are disposed on a first surface of the base film. The second signal wires are electrically connected to pads disposed in a second pad region of the semiconductor chip, wherein the second signal wires are disposed on a second surface of the base film, wherein the second surface of the base film is opposite to the first surface of the base film. A board includes a power source providing power to the semiconductor chip and a timing controller controlling the semiconductor chip. The first signal wires are connected to the display panel and the second signal wires are connected to the board.

In an exemplary embodiment of the inventive concept, the first signal wires are configured to transmit a drive signal generated in the semiconductor chip. The second signal wires are configured to transmit an input signal including a control signal to control the semiconductor chip from the timing controller or a power signal to provide power to the semiconductor chip from the power source.

In an exemplary embodiment of the inventive concept, wherein the COF package further includes via holes passing through the base film and connecting wires disposed on the first surface of the base film. The second signal wires are electrically connected to the connecting wires through the via holes.

According to an exemplary embodiment of the inventive concept, a display device includes a board including a power source and a timing controller, a COF package including a semiconductor chip, and a display panel including panel pads. The power source is electrically connected to the semiconductor chip through first signal wires. The timing controller is electrically connected to the semiconductor chip through second signal wires. The first and second signal wires are disposed on a second surface of a base film on which the semiconductor chip is disposed. The semiconductor chip is electrically connected to panel pads of the display panel through third signal wires to drive the display panel. The third signal wires are disposed on a first surface of the base film. The first and second surfaces of the base film are opposite with respect to each other.

In an exemplary embodiment of the inventive concept, the first signal wires are connected to first connecting wires through first via holes, wherein the first connecting wires and the third signal wires are disposed on the first surface of the base film.

In an exemplary embodiment of the inventive concept, the first connecting wires and the third signal wires do not overlap.

In an exemplary embodiment of the inventive concept, the second connecting wires and the first signal wires are substantially perpendicular to each other.

In an exemplary embodiment of the inventive concept, the first signal wires connect to pads of the semiconductor chip disposed on a first side of the semiconductor chip, the second signal wires connect to pads of the semiconductor chip disposed on a second side of the semiconductor chip, and the third signal wires connect to pads of the semiconductor chip disposed on a third side of the semiconductor chip.

In an exemplary embodiment of the inventive concept, the pads of the semiconductor chip disposed on the first side of the semiconductor chip, the pads of the semiconductor chip disposed on the second side of the semiconductor chip, and the pads of the semiconductor chip disposed on the third side of the semiconductor chip are disposed on a same surface of the base film.

### BRIEF DESCRIPTION OF THE DRAWINGS

The above and other features of the inventive concept will become more clearly understood by describing in detail exemplary embodiments of the inventive concept in conjunction with the accompanying drawings in which:

FIG. 1 is a view of a display device, according to an exemplary embodiment of the inventive concept;

FIG. 2 is an enlarged view of a part of a chip on film (COF) package, according to an exemplary embodiment of the inventive concept;

FIG. 3 is an enlarged view of a part of a COF package, according to an exemplary embodiment of the inventive concept;

FIG. 4 is a cross-sectional view taken along line I-I′ of FIG. 2, according to an exemplary embodiment of the inventive concept;

FIG. 5 is a view of a COF package, according to an exemplary embodiment of the inventive concept;

FIG. 6 is a view of a COF package, according to an exemplary embodiment of the inventive concept;

FIG. 7 is a view of a display device including the COF package of FIG. 5, according to an exemplary embodiment of the inventive concept;

FIG. 8 is a view of a display device including the COF package of FIG. 6, according to an exemplary embodiment of the inventive concept; and

FIG. 9 is a cross-sectional view of one end of a device assembly, according to an exemplary embodiment of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The exemplary embodiments of the inventive concept are provided so this disclosure may be thorough and complete and may convey the scope of the inventive concept to one of ordinary skilled in the art. It is understood that the disclosed exemplary embodiment of the inventive concept can be modified in various ways without departing from the scope of the inventive concept. Like reference numerals may refer to like elements throughout the specification. In the drawings, the thicknesses of layers and regions may be exaggerated for clarity.

It will be understood that terms such as those defined in commonly used dictionaries should be interpreted as having a meaning that is consistent with their meaning in the context of the relevant art and will not be interpreted in an idealized or overly formal sense unless explicitly so defined herein. The term “connect” as used herein may not mean just a physical connection but also an electrical connection.

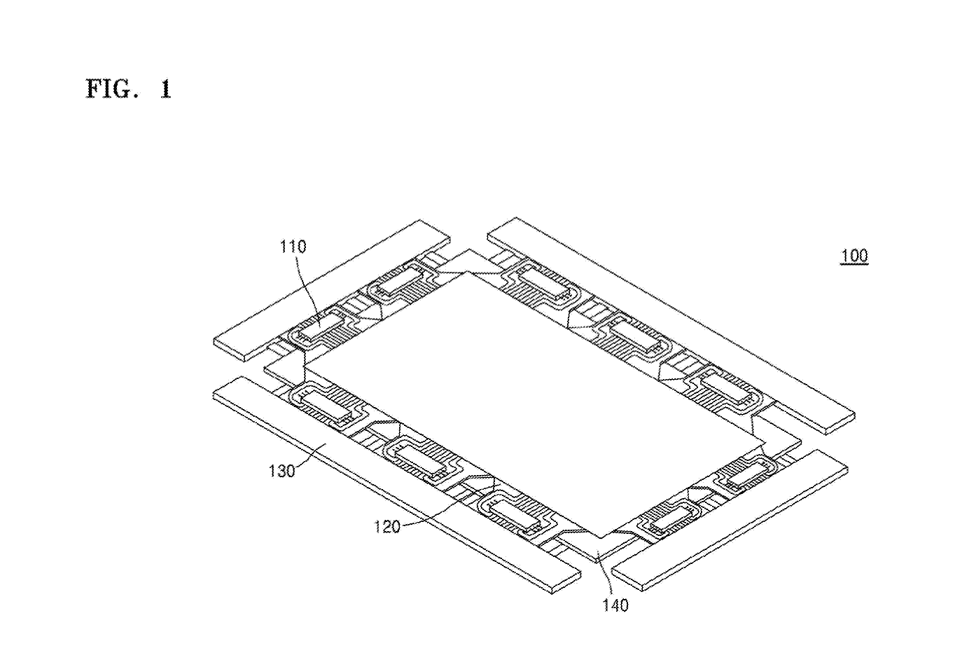

FIG. 1 is a view of a display device, according to an exemplary embodiment of the inventive concept.

Referring to FIG. 1, a display device 100 includes a chip on film (COF) package 120, a board 130 in which a power source and a timing controller are mounted and electrically connected thereto, and a display panel 140. The display panel 140 may include a plurality of pixels. The pixels may be formed in a region partitioned by scan lines and data lines. The pixels display an image corresponding to drive signals supplied from the COF package 120. The COF package 120 may be formed in an edge region of the display panel 140. The COF package 120 may include a semiconductor chip 110 for driving the display panel 140, and the semiconductor chip 110 may be mounted on a base film. The semiconductor chip 110 may include a driving integrated circuit (not shown) and the driving integrated circuit may be a scan driving circuit generating a scan signal for the pixels or a data driving circuit generating a data signal for the pixels. A drive signal described below is a signal generated in the semiconductor chip 110 and may correspond to a signal including at least one of the scan signal and the data signal.

According to an exemplary embodiment of the inventive concept, the COF package 120 may include first signal wires to transmit the drive signal corresponding to pixels generated in the semiconductor chip 110 included in the COF package 120 to the display panel 140. The COF package 120 may include second signal wires to transmit an input signal applied to the semiconductor chip 110 from the power source included in the board 130 or the timing controller. The second signal wires may be arranged on a surface of the base film on which the first signal wires are not disposed, to not overlap the first signal wires. This will be described below in detail.

In an exemplary embodiment of the inventive concept, the COF package 120 may include a base film including two or more layers. The semiconductor chip 110 is mounted on one of the two or more layers of the base film and the first signal wires transmitting (e.g., outputting) the drive signal may be disposed on a layer on which the semiconductor chip 110 is mounted. The second signal wires transmitting the input signal to the semiconductor chip 110 may be disposed on a layer that is not the layer on which the semiconductor chip 110 is mounted, from among the two or more layers of the base film of the COF package 120.

The COF package 120, according to an exemplary embodiment of the inventive concept, may have an increased signal wire structure. Therefore, to prevent a voltage drop in the semiconductor chip 110, it is possible to increase power transmitted to the semiconductor chip 110 by transmitting a power signal from a power source to the semiconductor chip 110 through the second signal wires. Both ends of the COF package 120 may be connected to the display panel 140 and the board 130 via an anisotropic conductive film or an anisotropic conductive paste that are a conductive adhesive material. However, this is merely an example and the inventive concept is not limited thereto. For example, the board 130 may be a printed circuit board (PCB) or a flexible PCB. The display device 100, according to an exemplary embodiment of the inventive concept, may be applied to various display devices such as a television (TV) or an electronic scoreboard.

The power source may provide the power signal to the semiconductor chip 110 through at least one signal wire included in the COF package 120. The power source may include a circuit such as a low drop out (LDO) regulator or a charge pump and may adjust the power signal to a power signal suitable to be applied to the semiconductor chip 110. In addition, the power source may correspond to a switching mode power supply (SMPS) so that the power signal may be adjusted to a power signal suitable to be applied to the semiconductor chip 110. However, the inventive concept is not limited thereto, and various methods may be applied to adjust the power signal.

The timing controller may provide control signals to control the semiconductor chip 110. The input signal provided from the power source and the timing controller to the COF package 120 may include at least one of the power signal and the control signal. The power source and the timing controller are electrically connected to the board 130 and may transmit the power signals and the control signals to the board 130.

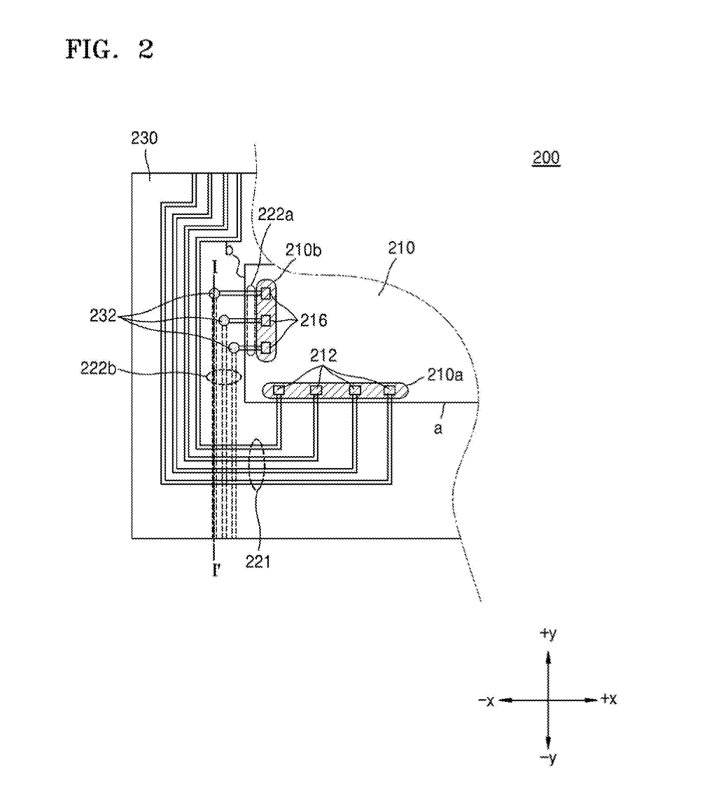

FIG. 2 is an enlarged view of a part of a COF package, according to an exemplary embodiment of the inventive concept.

Referring to FIG. 2, a COF package 200 includes a semiconductor chip 210, first signal wires 221, second signal wires 222b, connecting wires 222a connected to the second signal wires 222b, and a base film 230. The semiconductor chip 210 may be mounted on the base film 230. The base film 230 and the semiconductor chip 210 may be electrically connected through a plurality of pads included in the semiconductor chip 210. The semiconductor chip 210 may include at least one pad region in which the pads are disposed. For example, the semiconductor chip 210 may include a first pad region 210a placed adjacent to an “a” side of the semiconductor chip 210 and a second pad region 210b placed adjacent to a “b” side of the semiconductor chip 210. In an exemplary embodiment, the “a” side may correspond to a long side of the semiconductor chip 210 and the “b” side may correspond to a short side of the semiconductor chip 210. Therefore, the number of pads placed along the “a” side may be larger than the number of pads placed on the “b” side. The semiconductor chip 210 may include first pads 212 in the first pad region 210a and second pads 216 in the second pad region 210b.

As described with reference to FIG. 1, the semiconductor chip 210 may be a scan driving circuit generating a scan signal for pixels or a data driving circuit generating a data signal for the pixels. However, the inventive concept is not limited thereto; the semiconductor chip 210 may generate a data signal for driving various devices other than the display panel 140 of FIG. 1. A drive signal described below is a signal generated in the semiconductor chip 210 and may correspond to a signal including at least one of the scan signal and the data signal.

In an exemplary embodiment of the inventive concept, the “a” side and the “b” side of the semiconductor chip 210 may be formed approximately orthogonally to each other and thus the first pads 212 and the second pads 216 may be arranged approximately orthogonally to each other. The first pads 212 are connected to the first signal wires 221. The first signal wires 221 are configured to transmit the drive signal generated in the semiconductor chip 210 to the outside (e.g., the display panel 140) and may be arranged on a first surface of the base film 230. Further, the first signal wires 221 may extend in a +y direction.

The second pads 216 may be connected to the connecting wires 222a and the connecting wires 222a may be connected to the second signal wires 222b. The second signal wires 222b may be configured to transmit an input signal to the semiconductor chip 110, the input signal including at least one of the power signal from the power source mounted on the board 130 of FIG. 1 and the control signal of the semiconductor chip 110 from the timing controller. The connecting wires 222a may be disposed on a first surface of the base film 230. The second signal wires 222b may be arranged on a second surface of the base film 230, which is opposite to the first surface of the base film 230, to not overlap the first signal wires 221. In an exemplary embodiment of the inventive concept, the base film 230 may include first via holes 232. The second signal wires 222b may be disposed on the second surface of the base film 230. The connecting wires 222a may be arranged on the first surface of the base film 230. The connecting wires 222a and the second signal wires 222b may be electrically connected through the first via holes 232. Further, in an exemplary embodiment of the inventive concept, the second signal wires 222b may extend in a −y direction. Therefore, the first signal wires 221 and the second signal wires 222b may extend in different directions.

In an exemplary embodiment of the inventive concept, the COF package 200 includes the base film 230, which includes two or more layers. The semiconductor chip 210 may be mounted on one of the layers of the base film 230, the first signal wires 221 transmitting (e.g., outputting) the drive signal generated in the semiconductor chip 210 may be disposed on the layer on which the semiconductor chip 210 is mounted, and the second signal wires 222b transmitting the input signal to the semiconductor chip 210 may be disposed on a layer that is different from the layer on which the semiconductor chip 210 is mounted. However, the inventive concept is not limited to the pads and the signal wires described above, and a display device may include various pads and signal wires disposed in various ways.

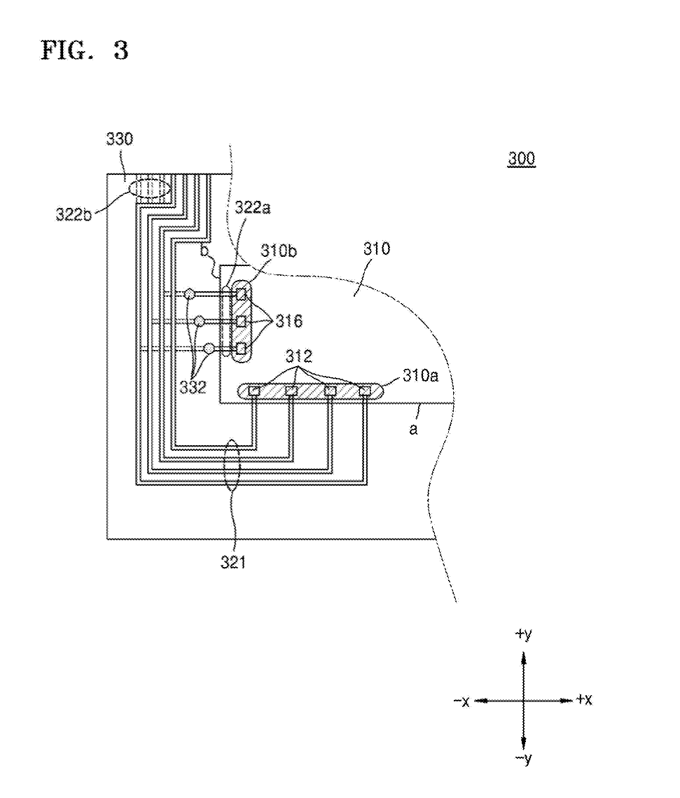

FIG. 3 is an enlarged view of a part of a COF package, according to an exemplary embodiment of the inventive concept.

Referring to FIG. 3, a COF package 300 includes a semiconductor chip 310, first signal wires 321, second signal wires 322b, connecting wires 322a connected to the second signal wires 322b, and a base film 330. The semiconductor chip 310 may be mounted on the base film 330, and the base film 330 and the semiconductor chip 310 may be electrically connected to each other through a plurality of pads included in the semiconductor chip 310. The semiconductor chip 310 may include at least one pad region in which the pads are placed. In an exemplary embodiment of the inventive concept, the semiconductor chip 310 may include a first pad region 310a placed adjacent to an “a” side of the semiconductor chip 310 and a second pad region 310b placed adjacent to a “b” side of the semiconductor chip 310. Further, the semiconductor chip 310 may include first pads 312 that are pads of the first pad region 310a and second pads 316 that are pads of the second pad region 310b.

The first pads 312 are connected to the first signal wires 321. The first signal wires 321, which are configured to transmit a drive signal generated in the semiconductor chip 310 to the outside, may be disposed on a first surface of the base film 330. Further, the first signal wires 321 may extend in the +y direction.

The second pads 316 may be connected to the connecting wires 322a and the connecting wires 322a may be connected to the second signal wires 322b. The second signal wires 322b may be configured to transmit the generated drive signal to the outside. A higher quality image may be provided by providing the drive signal generated in the semiconductor chip 310 through the first signal wires 321 and the second signal wires 322b. The connecting wires 322a may be arranged on the first surface of the base film 330 and the second signal wires 322b may be arranged on a second surface of the base film 330 to not overlap the first signal wires 321. The second surface of the base film 330 is located opposite to the first surface of the base film 330. In an exemplary embodiment of the inventive concept, the base film 230 includes first via holes 332 so the second signal wires 322b may be disposed on the second surface of the base film 330. Accordingly, the connecting wires 322a may be disposed on the first surface of the base film 330 and the second signal wires 322b may be disposed on the second surface of the base film 330. The connecting wires 322a and the second signal wires 322b may be electrically connected through the first via holes 332. Further, in an exemplary embodiment of the inventive concept, the second signal wires 322b extend in the +y direction. Therefore, the first signal wires 321 and the second signal wires 322b may extend in the same direction.

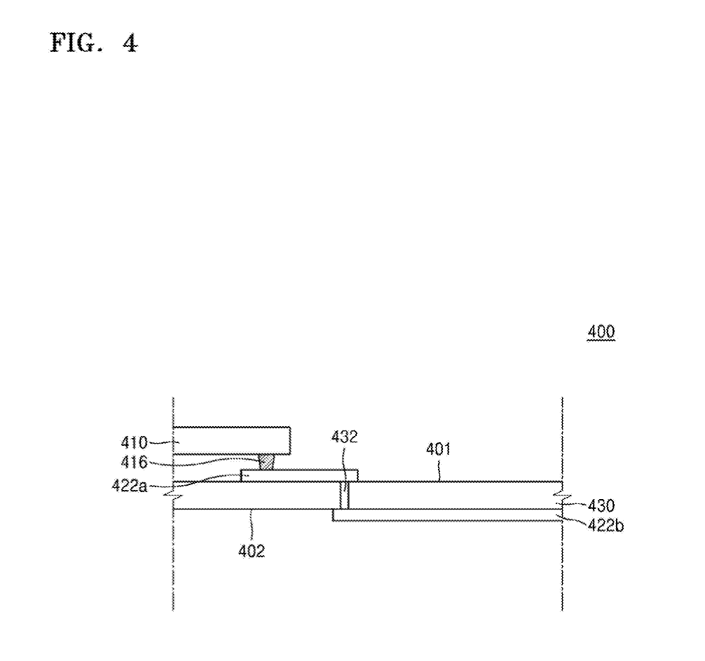

FIG. 4 is a cross-sectional view taken along line I-I′ of FIG. 2, according to an exemplary embodiment of the inventive concept.

Referring to FIGS. 2 and 4, a connecting wire 422a is arranged on a first surface 401 of a base film 430 and may be electrically connected to a second pad 416 of the second pad region 210b. The connecting wire 422a may be electrically connected to a second signal wire 422b through a via hole 432. A via plug may be formed in the via hole 432 to connect the connecting wire 422a and the second signal wire 422b. The second signal wire 422b may be disposed on a second surface 402 of the base film 430. The second signal wire 422b may not overlap the first signal wires 221 of FIG. 2 when disposed on the second surface 402. In other words, the second signal wire 422b and the first signal wires 221 do not cross because they are disposed on different surfaces. In an exemplary embodiment of the inventive concept, the different surfaces are different surfaces of the same layer, for example, the base film 430. In an exemplary embodiment of the inventive concept, the different surfaces are surfaces of different layers. An input signal may be transmitted from the board 130 of FIG. 1 to the semiconductor chip 410 through the second signal wire 422b. In an exemplary embodiment of the inventive concept, a drive signal generated in the semiconductor chip 410 may be transmitted to the display panel 140 of FIG. 1. The connecting wire 422a and the second pad 416 may be integrally formed of a same component.

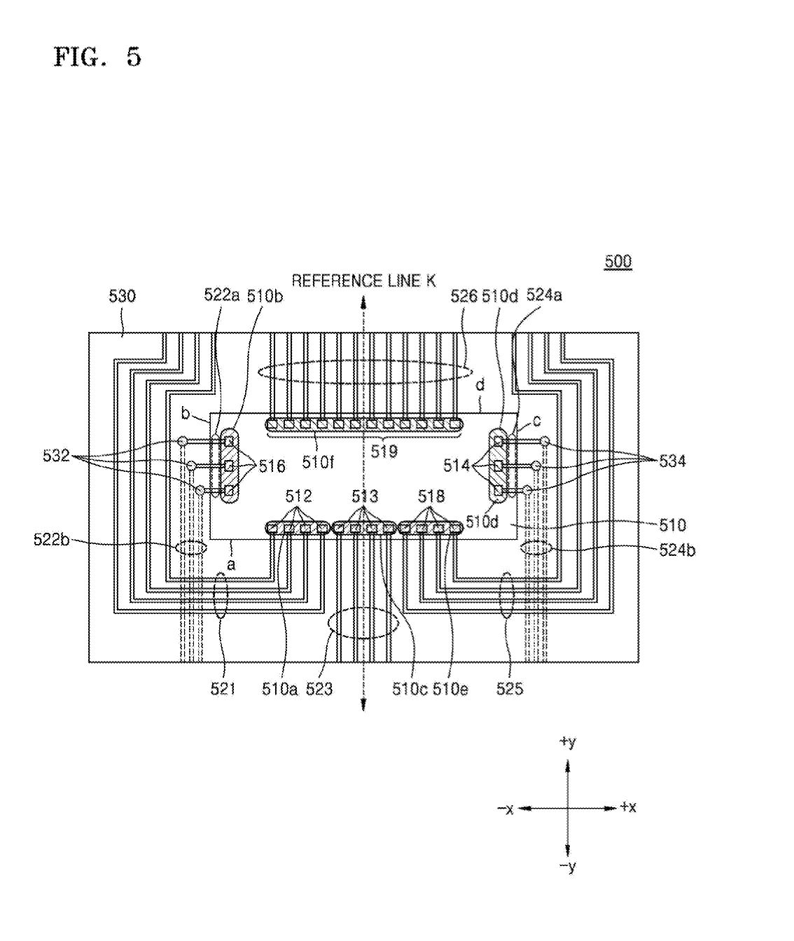

FIG. 5 is a view of a COF package, according to an exemplary embodiment of the inventive concept.

Referring to FIG. 5, a COF package 500 includes a semiconductor chip 510, first signal wires 521, second signal wires 522b, first connecting wires 522a connected to the second signal wires 522b, third signal wires 523, fourth signal wires 524b, second connecting wires 524a connected to the fourth signal wires 524b, fifth signal wires 525, sixth signal wires 526, and a base film 530.

The semiconductor chip 510 may be mounted on the base film 530, and the base film 530 and the semiconductor chip 510 may be electrically connected to each other through a plurality of pads included in the semiconductor chip 510. The semiconductor chip 510 may include at least one pad region in which the pads are placed. In an exemplary embodiment of the inventive concept, the semiconductor chip 510 includes a first pad region 510a placed adjacent to an “a” side of the semiconductor chip 510, a second pad region 510b placed adjacent to a “b” side of the semiconductor chip 510, a third pad region 510c, a fourth pad region 510d placed adjacent to a “c” side of the semiconductor chip 510, a fifth pad region 510e, and a sixth pad region 510f placed adjacent to a “d” side of the semiconductor chip 510. Further, the semiconductor chip 510 may include first pads 512 that are pads of the first pad region 510a, second pads 516 that are pads of the second pad region 510b, third pads 513 that are pads of the third pad region 510c, fourth pads 514 that are pads of the fourth pad region 510d, fifth pads 518 that are pads of the fifth pad region 510e, and sixth pads 519 that are pads of the sixth pad region 510f.

In an exemplary embodiment of the inventive concept, the “a” side and the “b” side of the semiconductor chip 510 may be formed approximately orthogonal to each other and thus the first pads 512 and the second pads 516 may be arranged approximately orthogonal to each other. Further, the “c” side and the “a” side of the semiconductor chip 510 may be formed approximately orthogonal to each other and thus the fourth pads 514 and the fifth pads 518 may be arranged approximately orthogonal to each other. Descriptions of the first and second signal wires 521 and 522b may be omitted since the first and second signal wires 521 and 522b may be similar to the first and second signal wires 221 and 222b of FIG. 2. In an exemplary embodiment of the inventive concept, the second signal wires 522b and the first connecting wires 522a are substantially perpendicular to each other. In an exemplary embodiment of the inventive concept, the second signal wires 522b and the first connecting wires 522a are oblique with respect to each other.

The third pad region 510c, that is placed on the “a” side of the semiconductor chip 510, may be disposed adjacent to the first pad region 510a. The third pads 513 placed in the third pad region 510c may be connected to the third signal wires 523. For example, the third signal wires 523 are configured to transmit an input signal applied to the semiconductor chip 510 and may be disposed on the first surface of the semiconductor chip 510. The first signal wires 521 may be disposed on the first surface of the semiconductor chip 510. The third signal wires 523 may extend in the −y direction, similarly to the second signal wires 522b.

The fifth pad region 510e, that is placed on the “a” side of the semiconductor chip 510, may be placed adjacent to the third pad region 510c. The fifth pads 518 placed in the fifth pad region 510e may be connected to the fifth signal wires 525. The fifth signal wires 525 are configured to transmit a drive signal generated in the semiconductor chip 510 to the outside and may be disposed on the first surface of the base film 530. The fifth signal wires 525 may extend in the +y direction. In an exemplary embodiment of the inventive concept, the first signal wires 521 may extend adjacent to the “b” side and the fifth signal wires 525 may extend adjacent to the “c” side, unlike the first signal wires 521.

The fourth pads 514 may be connected to the second connecting wires 524a and the second connecting wires 524a may be connected to the fourth signal wires 524b. The fourth signal wires 524b may be configured to transmit an input signal including at least one of the power signal from the power source mounted on the board 130 of FIG. 1 and the control signal of the semiconductor chip 510 from the timing controller to the semiconductor chip 510. The second connecting wires 524a may be disposed on the first surface of the base film 530 and the fourth signal wires 524b may be disposed on a second surface of the base film 530 to not overlap the fifth signal wires 525. The second surface of the base film 530 is opposite to the first surface of the base film 530. In an exemplary embodiment of the inventive concept, the base film 530 includes second via holes 534 so the fourth signal wires 524b may be disposed on the second surface of the base film 530. Accordingly, the second connecting wires 524a may be disposed on the first surface of the base film 530 and the fourth signal wires 524b may be disposed on the second surface of the base film 530. The second connecting wires 524a and the fourth signal wires 524b may be electrically connected through the second via holes 534. Further, in an exemplary embodiment of the inventive concept, the fourth signal wires 524b extend in the −y direction. Therefore, the fourth signal wires 524b and the fifth signal wires 525 may extend in different directions.

The sixth pad region 510f is placed on the “d” side of the semiconductor chip 510 and the sixth pads 519 in the sixth pad region 510f may be connected to the sixth signal wires 526. The sixth signal wires 526 may be configured to transmit a drive signal generated in the semiconductor chip 510. In other words, the sixth signal wires 526 may output a drive signal to another electronic component, for example, a display panel. The sixth signal wires 526 are illustrated as being arranged only on the first surface of the base film 530 in FIG. 5 but the inventive concept not limited thereto; a part of the sixth signal wires 526 may be arranged on the second surface of the base film 530. Therefore, more of the pads of the sixth pad region 510f and more of the sixth signal wires 526 are connected to each other and thus more of the drive signals may be transmitted to the outside.

Further, arrangements of the second and fourth signal wires 522b and 524b may be symmetrical to each other based on a reference line K that is a straight line extended in a +y direction from a center portion of the semiconductor chip 510. Moreover, the first and fifth signal wires 521 and 525 may be symmetrical to each other about the reference line K. In an exemplary embodiment of the inventive concept, unlike as depicted FIG. 5, the second signal wires 522b may extend in the +y direction in the same manner as the second signal wires 322b of FIG. 3. In an exemplary embodiment of the inventive concept, the arrangements of the second and fourth signal wires 522b and 524b may be asymmetrical to each other. However, the inventive concept is not limited to the pads and the signal wires described above, and a display device may be disposed in various ways and may include various pads and signal wires.

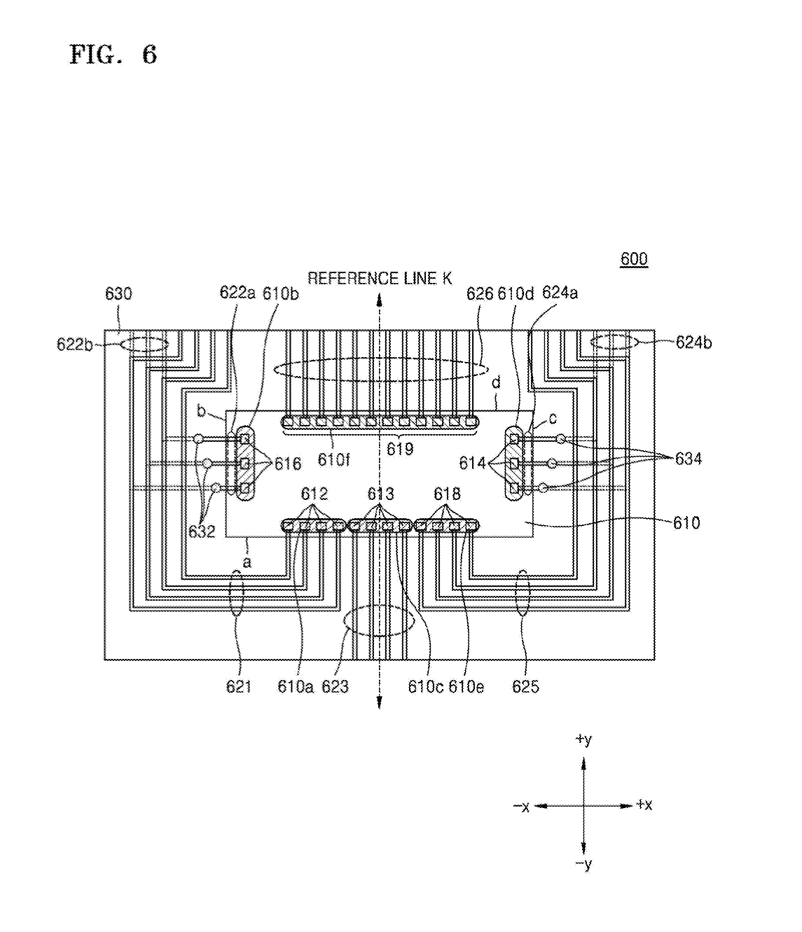

FIG. 6 is a view of a COF package, according to an exemplary embodiment of the inventive concept.

Referring to FIG. 6, a COF package 600 includes a semiconductor chip 610, first signal wires 621, second signal wires 622b, first connecting wires 622a connected to the second signal wires 622b, third signal wires 623, fourth signal wires 624b, second connecting wires 624a connected to the fourth signal wires 624b, fifth signal wires 625, sixth signal wires 626, and a base film 630.

Descriptions of the first signal wires 621, the third signal wires 623, the fifth signal wires 625, and the sixth signal wires 626 may be omitted since first signal wires 621, the third signal wires 623, the fifth signal wires 625, and the sixth signal wires 626 may be similar to the first signal wires 521, the third signal wires 523, the fifth signal wires 525, and the sixth signal wires 526 of FIG. 5, respectively. The second signal wires 622b may extend in a +y direction, unlike the second signal wires 522b of FIG. 5. Further, the second signal wires 622b may be configured to transmit a drive signal generated in the semiconductor chip 610 to the outside. The first and second signal wires 621 and 622b may extend in a same direction. In an exemplary embodiment of the inventive concept, the first and second signal wires 621 and 622b extend in the +y direction.

The fourth signal wires 624b may extend in the +y direction, unlike the fourth signal wires 524b of FIG. 5. Further, the fourth signal wires 624b may be configured to transmit the drive signal generated in the semiconductor chip 610 to the outside. The fourth and fifth signal wires 624b and 625 may extend in a same direction. In an exemplary embodiment of the inventive concept, the fourth and fifth signal wires 624b and 625 extend in the +y direction. Further, the second and fourth signal wires 622b and 624b may be symmetrical to each other with respect to the reference line K that is a straight line extended in the +y direction from a center portion of the semiconductor chip 610. Moreover, the first and fifth signal wires 621 and 625 may be symmetrical to each other about the reference line K.

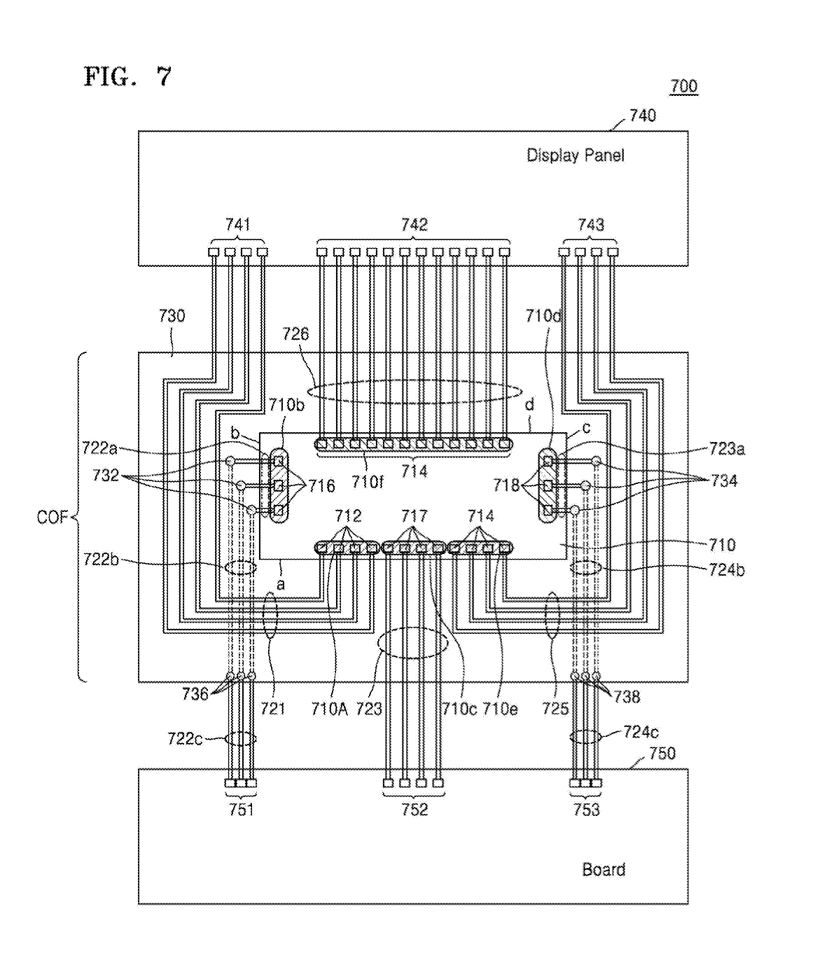

FIG. 7 is a view of a display device including the COF package of FIG. 5, according to an exemplary embodiment of the inventive concept.

Referring to FIG. 7, a display device 700 includes a COF package COF, a display panel 740, and a board 750. Since the COF package COF of the display device 700 corresponds to the COF package 500 of FIG. 5, the following description may focus mostly on newly illustrated components. The COF package COF, the board 750 and the display panel 740 of the display device 700 are illustrated in FIG. 7 as being spaced apart from each other by a given distance. However, the COF package COF, the board 750 and the display panel 740 of the display device 700 may be disposed adjacent to each other without any space therebetween. Third and fourth via holes 736 and 738 may be formed on a base film 730. The COF package COF may further include third connecting wires 722c electrically connected to the second signal wires 722b through the third via holes 736. In an exemplary embodiment of the inventive concept, the third connecting wires do not overlap sixth signal wires 726. In addition, the COF package COF may include fourth connecting wires 724c electrically connected to fourth signal wires 724b through the fourth via holes 738. However, this is merely an exemplary embodiment of the inventive concept, and the third and fourth via holes 736 and 738 may be formed on the board 750. In addition, first board pads 751 of the board 750 may be connected to the second signal wires 722b and third board pads 753 of the board 750 may be connected to the fourth signal wires 724b without forming the third and fourth via holes 736 and 738. Hereinafter, this will be described based on the third and fourth via holes 736 and 738 being formed on the base film 730.

The display panel 740 may include first to third panel pads 741 to 743 to be connected to the signal wires 721, 725, and 726 of the COF package COF. As displayed in FIG. 7, The “d” side of the semiconductor chip 710 is closer to the display panel 740 than the “a”, “b”, and “c” sides. Therefore, the first panel pads 741 may be connected to the first signal wires 721, the second panel pads 742 may be connected to the sixth signal wires 726, and the third panel pads 743 may be connected to the fifth signal wires 725. The semiconductor chip 710 may output a drive signal generated in the semiconductor chip 710 to the display panel 740 through the first signal wires 721, the fifth signal wires 723, and the sixth signal wires 726.

The board 750 may include first to third board pads 751 to 753. As shown in FIG. 7, the “a” side of the semiconductor chip 710 is closer to the board 750 than “b”, “c”, and “d” sides. Therefore, the first board pads 751 may be connected to the third connecting wires 722c, the second board pads 752 may be connected to third signal wires 723, and the third board pads 753 may be connected to the fourth connecting wires 724c. In an exemplary embodiment of the inventive concept, the semiconductor chip 710 may receive an input signal including at least one of a power signal generated from a power source mounted on the board 750 and a control signal generated from a timing controller mounted on the board 750, through the third connecting wires 722c, the third signal wires 723, and the fourth connecting wires 724c.

For example, when the power source is mounted on the board 750 and connected to the first board pads 751, the power signal generated from the power source may be transmitted to the semiconductor chip 710 through the third connecting wires 722c. Thus power supply to the semiconductor chip 710 may be increased. Further, when the timing controller is mounted on the board 750 and connected to the first board pads 751, a control signal generated from the timing controller may be transmitted to the semiconductor chip 710 through the third connecting wires 722c. In an exemplary embodiment of the inventive concept, a control signal generated from the timing controller may be transmitted to the semiconductor chip 710 through the fourth connecting wires 724c. In other words, the operations and accuracy of the semiconductor chip 710 may be increased by using both sides of the base film 730 to input control and power signals to the semiconductor chip 710 and to output control and power signals from the semiconductor chip 710.

However, the inventive concept is not limited to the pads and the signal wires described above, and a display device may be disposed in various ways to include various pads and signal wires. The panel pads 741 to 743 of the display panel 740 and the board pads 751 to 753 of the board 750 may be a part of wires formed of a metal.

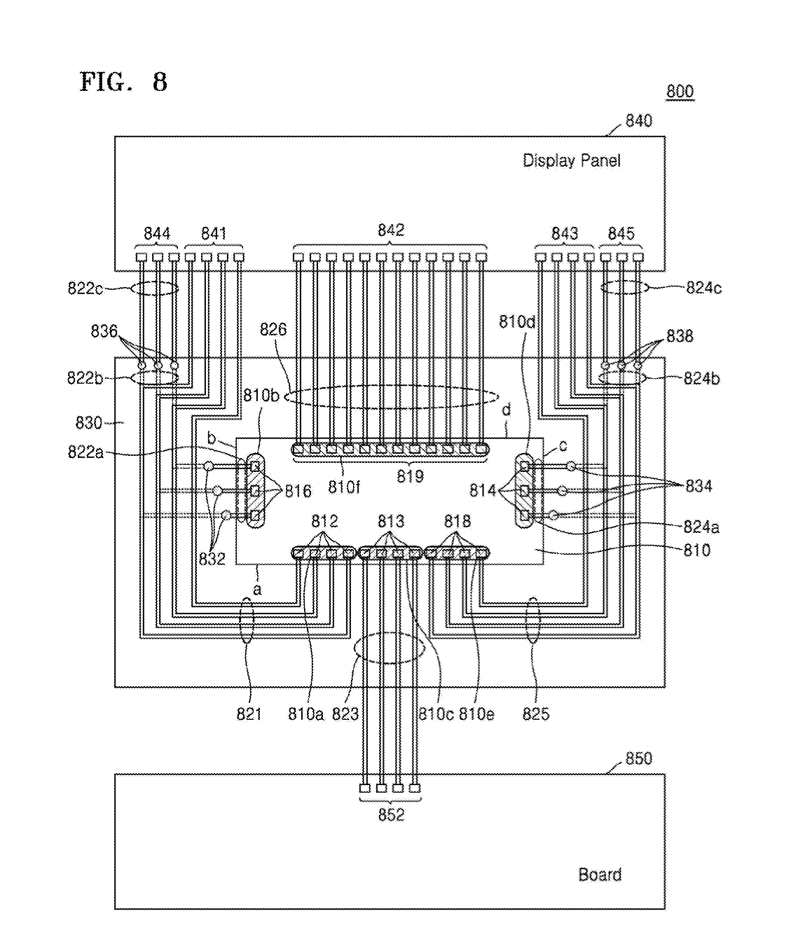

FIG. 8 is a view of a display device including the COF package of FIG. 6, according to an exemplary embodiment of the inventive concept.

Referring to FIG. 8, a display device 800 includes a COF package COF, a display panel 840, and a board 850. Since the COF package COF of the display device 800 corresponds to the COF package 600 of FIG. 6, the following description may focus mostly on newly illustrated components. The COF package COF, the board 850, and the display panel 840 of the display device 800 are illustrated in FIG. 8 as being spaced apart from each other by a given distance. However, the COF package COF, the board 850, and the display panel 840 of the display device 800 may be disposed adjacent to each other without any space therebetween. Third and fourth via holes 836 and 838 may be formed on a base film 830.

The COF package COF may include third connecting wires 822c electrically connected to the second signal wires 822b through the third via holes 836. In addition, the COF package COF may include fourth connecting wires 824c electrically connected to fourth signal wires 824b through the fourth via holes 838. However, this is merely exemplary. In an exemplary embodiment of the invention, the third and fourth via holes 836 and 838 may be formed on the board 850, or fourth panel pads 844 of the display panel 840 may be connected to the second signal wires 822b and fifth panel pads 845 of the display panel 840 may be connected to the fourth signal wires 824b without forming the third and fourth via holes 836 and 838. Hereinafter, this will be described based on the third and fourth via holes 836 and 838 being formed on the base film 830.

The display panel 840 may include first to third panel pads 841 to 843. The first panel pads 841 may be connected to the first signal wires 821, the second panel pads 842 may be connected to the sixth signal wires 826, and the third panel pads 843 may be connected to the fifth signal wires 825. Further, the fourth panel pads 844 may be connected to the third connecting wires 822c and the fifth panel pads 845 may be connected to the fourth connecting wires 824c. The semiconductor chip 810 may generated a drive signal and transmit the drive signal to the display panel 840 through the first signal wires 821, the fifth signal wires 825, the sixth signal wires 826, the third connecting wires 822c, and the fourth connecting wires 824c.

The board 850 may include board pads 852. The board pads 852 may be connected to the third signal wires 823. The semiconductor chip 810 may receive an input signal including at least one of a power signal generated from a power source mounted on the board 850 and a control signal generated from a timing controller mounted on the board 850 through the third signal wires 823. Further, in an exemplary embodiment of the inventive concept, the panel pads 841 to 845 of the display panel 840 and the board pads 852 of the board 850 may be a part of wires formed of a metal.

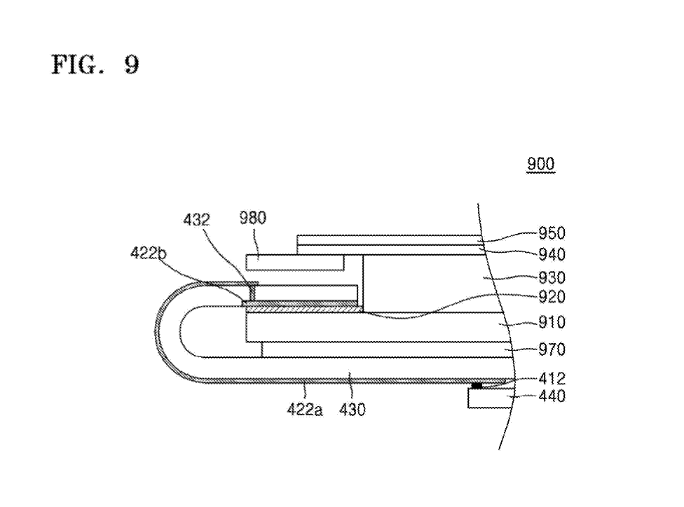

FIG. 9 is a cross-sectional view of one end of a device assembly, according to an exemplary embodiment of the inventive concept. In an exemplary embodiment of the inventive concept, a device assembly 900 is a display device.

Referring to FIGS. 4 and 9, the device assembly 900 includes a panel substrate 910 and may include a wire 920 formed on the panel substrate 910 to receive a signal supplied from the COF package 400 of FIG. 4, a display panel 930 which is formed on the panel substrate 910 and displays an image, a touch panel 940 formed on the display panel 930, and a touch drive unit 980 for driving the touch panel 940. In addition, the display panel 900 may include a protective film 950 protecting the touch panel 940.

The second signal wire 422b of the COF package 400 of FIG. 4 and the pad 920 may be integrated or bonded together. The connecting wire 422a may be electrically connected to the second signal wire 422b through the via hole 432 including the via plug. The second signal wire 422b may be electrically connected to the pad 420.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A chip on film (COF) package comprising:
a base film;
a semiconductor chip disposed on the base film, wherein the semiconductor chip comprises a plurality of pads and a driving integrated circuit;
first signal wires configured to output a drive signal generated in the driving integrated circuit, wherein the first signal wires are electrically connected to pads disposed in a first pad region, wherein the first pad region is disposed on a first side of the semiconductor chip, and wherein the first signal wires are disposed on a first surface of the base film; and
second signal wires electrically connected to pads disposed in a second pad region, wherein the second pad region is disposed on a second side of the semiconductor chip, wherein the second signal wires are disposed on a second surface of the base film, and wherein the second surface of the base film is opposite to the first surface of the base film.

2. The COF package of claim 1, wherein
the first side of the semiconductor chip is longer than the second side of the semiconductor chip, and
the pads of the first and second pad regions are arranged approximately orthogonal to each other.

3. The COF package of claim 1, wherein a drive signal generated in the semiconductor chip is output through the second signal wires.

4. The COF package of claim 1, wherein the second signal wires are configured to transmit an input signal to the semiconductor chip.

5. The COF package of claim 4, wherein the input signal comprises a power signal to supply power to the driving integrated circuit or a control signal to control the semiconductor chip.

6. The COF package of claim 1, the COF package further comprising:
first via holes passing through the base film and first connecting wires disposed on a first surface of the base film, wherein the second signal wires are electrically connected to the first connecting wires through the first via holes.

7. The COF package of claim 1, wherein the first and second signal wires extend in opposite directions with respect to each other.

8. The COF package of claim 1, wherein the semiconductor chip further comprises a third pad region disposed on the first side of the semiconductor chip, wherein the third pad region is adjacent to the second pad region.

9. The COF package of claim 8, the COF package further comprising:
third signal wires connected to pads disposed in the third pad region, wherein the third signal wires are disposed on the first surface of the base film, and wherein the third signal wires are configured to transmit an input signal to the semiconductor chip.

10. The COF package of claim 8, wherein
the second pad region is disposed on the second side of the semiconductor chip,
wherein the semiconductor chip further comprises a fourth pad region disposed on a third side of the semiconductor chip, wherein the third side of the semiconductor chip faces the second side of the semiconductor chip, and
wherein the COF package further comprises fourth signal wires connected to pads disposed in the fourth pad region, wherein the fourth signal wires are disposed on the second surface of the base film, and wherein the fourth signal wires are configured to transmit an input signal to the semiconductor chip.

11. The COF package of claim 10, wherein the second signal wires and the fourth signal wires are symmetrical to each other based on a reference line disposed between the second and fourth signal wires.

12. The COF package of claim 1, wherein the driving integrated circuit is a scan driving circuit generating a scan signal or a data driving circuit generating a data signal.

13. A display device comprising:
a display panel comprising a plurality of pixels;
a chip on film (COF) package comprising a semiconductor chip disposed on a base film, wherein the semiconductor chip is configured to drive the display panel, wherein the COF package comprises first signal wires and second signal wires,
wherein the first signal wires are electrically connected to pads disposed in a first pad region of the semiconductor chip, wherein the first signal wires are disposed on a first surface of the base film,
wherein the second signal wires are electrically connected to pads disposed in a second pad region of the semiconductor chip, wherein the second signal wires are disposed on a second surface of the base film, wherein the second surface of the base film is opposite to the first surface of the base film; and
a board including a power source providing power to the semiconductor chip and a timing controller controlling the semiconductor chip, wherein
the first signal wires are connected to the display panel and the second signal wires are connected to the board.

14. The display device of claim 13, wherein
the first signal wires are configured to transmit a drive signal generated in the semiconductor chip, and
the second signal wires are configured to transmit an input signal comprising a control signal to control the semiconductor chip from the timing controller or a power signal to provide power to the semiconductor chip from the power source.

15. The display device of claim 13, wherein the COF package further comprises via holes passing through the base film and connecting wires disposed on the first surface of the base film,
wherein the second signal wires are electrically connected to the connecting wires through the via holes.

16. A display device comprising:
a board including a power source and a timing controller;
a chip on film (COF) package including a semiconductor chip; and
a display panel including panel pads,
wherein the power source is electrically connected to the semiconductor chip through first signal wires, wherein the timing controller is electrically connected to the semiconductor chip through second signal wires,
wherein the first and second signal wires are disposed on a second surface of a base film on which the semiconductor chip is disposed,
wherein the semiconductor chip is electrically connected to panel pads of the display panel through third signal wires to drive the display panel,
wherein the third signal wires are disposed on a first surface of the base film, wherein the first and second surfaces of the base film are opposite with respect to each other.

17. The display device of claim 16, wherein the first signal wires are connected to first connecting wires through first via holes, wherein the first connecting wires and the third signal wires are disposed on the first surface of the base film.

18. The display device of claim 17, wherein the first connecting wires and the third signal wires do not overlap.

19. The display device of claim 16, wherein the first connecting wires and the first signal wires are substantially perpendicular to each other.

20. The display device of claim 16, wherein the first connecting wires connect to pads of the semiconductor chip disposed on a first side of the semiconductor chip, the second connecting wires connect to pads of the semiconductor chip disposed on a second side of the semiconductor chip, and the third connecting wires connect to pads of the semiconductor chip disposed on a third side of the semiconductor chip.
